(19) United States
(12) Patent Application Publication
(10) Pub. No.: US 2024/0099518 A1
(43) Pub. Date: Mar. 28, 2024

(54) CORDLESS IMMERSIBLE BATH JET APPARATUS

(71) Applicant: CONAIR LLC, Stamford, CT (US)

(72) Inventor: Kwan Shing Benny SIU, Tseung Kwan O (HK)

(73) Assignee: CONAIR LLC, Stamford, CT (US)

(21) Appl. No.: 17/955,121

(22) Filed: Sep. 28, 2022

(51) Int. Cl. A47K 3/10; B01D 29/92; C02F 1/00; F04D 13/06; F04D 13/08

(52) U.S. Cl. CPC A47K 3/10; B01D 29/92; C02F 1/001; F04D 13/068; F04D 13/08; C02F 2103/42

(57) ABSTRACT

A bath jet apparatus includes a housing and a motor in the housing to rotate an impeller. The bath jet apparatus is cordless.

### BACKGROUND

### 1. Field of the Disclosure

The present disclosure relates to bath jets. In particular, the present disclosure is related to a cordless immersible bath jet apparatus.

### 2. Description of Related Art

Bath jets are positioned in bathtubs, hot tubs, spas and the like to generate a flow of water therein. The flow of water generated by the bath jets can create a desirable feel around the body and/or massage the body. However, not all bathtubs have bath jets. Accordingly, if a person prefers generation of a water flow while taking a bath, a separate device is needed. Currently available separate devices to generate a water flow in a bathtub have undesirable drawbacks.

Accordingly, it has been determined by the present disclosure that there is a continuing need for a device that overcomes, alleviates, and/or mitigates one or more of the aforementioned and other deleterious effects of prior devices.

### SUMMARY

The present disclosure provides a bath jet apparatus that includes a housing and a motor in the housing to rotate an impeller. The bath jet apparatus is cordless.

The above-described and other features and advantages of the present disclosure will be appreciated and understood by those skilled in the art from the following detailed description, drawings, and appended claims.

### DESCRIPTION OF THE DRAWINGS

FIG. 1 is a front perspective view of a bath jet apparatus according to the present disclosure.

FIG. 2 is a front view of FIG. 1.

FIG. 3 is a side view of FIG. 1.

FIG. 4 is a top view of FIG. 1.

FIG. 5 is an exploded front perspective view of FIG. 1.

FIG. 6 is a front perspective view of a motor housing of the bath jet apparatus of FIG. 1.

### DETAILED DESCRIPTION

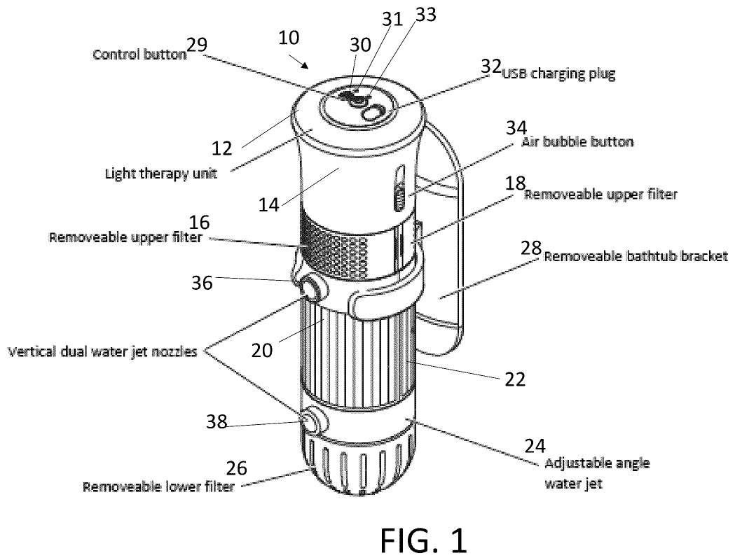

Referring to the drawings and in particular to FIG. 1, an exemplary embodiment of a bath jet apparatus according to the present disclosure is shown and is generally referred to by reference numeral 10. Advantageously, bath jet apparatus 10 can generate a water flow in a bathtub while being both cordless and fully submersible.

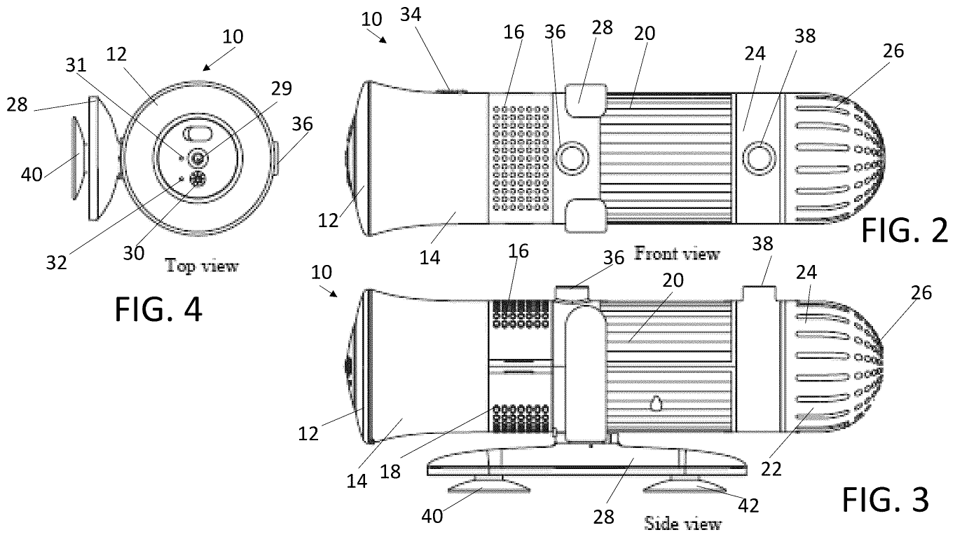

Referring to FIGS. 1-3, bath jet apparatus 10 has a cover 12, a seal ring 14, a first removeable upper filter 16, a second removeable upper filter 18, a front housing 20, a rear housing 22, a nozzle assembly 24, a removeable lower filter 26 and a removeable bathtub bracket 28. A control button 29, a lighting button 30, a first LED 31 and a second LED 33 extend through cover 12. Cover 12 has an opening to access a USB charging plug 32. An air bubble button 34 extends through seal ring 14. A nozzle 36 is formed in front housing 20. A nozzle 38 is formed in nozzle assembly 24. As shown in FIGS. 3 and 4, removeable bathtub bracket 28 is connected to two suction cups 40, 42.

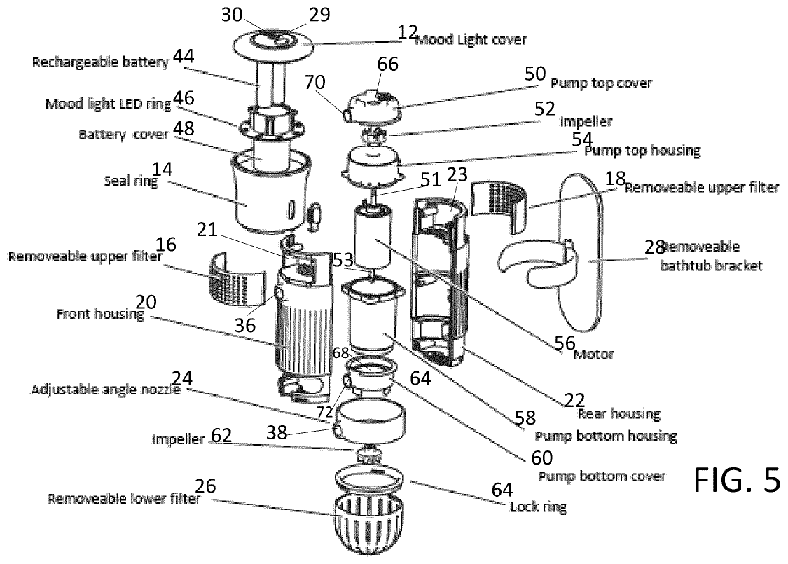

Still referring to FIGS. 1-3, cover 12 is connected to seal ring 14 on a first side of seal ring 14. Seal ring 14 is connected to front housing 20 and rear housing 22 on a second side that is opposite the first side of seal ring 14. Front housing 20 and rear housing 22 can be rotatably connected to seal ring 14. Front housing 20 is connected to rear housing 22. First removeable upper filter 16 removably connects to front housing 20 to cover an opening 21 (FIG. 5) through front housing 20. Second removeable upper filter 18 removably connects to rear housing 22 to cover an opening 23 (FIG. 5) through rear housing 22. Nozzle assembly 24 is connected to both front housing 20 and rear housing 22 on a side of front housing 20 and rear housing 22 that is opposite seal ring 14. Removeable lower filter 26 connects to nozzle assembly 24 on a side of nozzle assembly 24 that is opposite the side of nozzle assembly 24 that connects to front housing 20 and rear housing 22. Removeable bathtub bracket 28 removably connects to front housing 20 and rear housing 22.

Referring to FIG. 5, rechargeable batteries 44, a ring of LEDs 46 forming a mood light and a battery cover 48 are housed between cover 12 and seal ring 14. Rechargeable batteries 44 are positioned in battery cover 48 and ring of LEDs 46 is positioned around battery cover 48 when assembled. A pump top cover 50, an impeller 52, a pump top housing 54, a motor 56, a pump bottom housing 58, a pump bottom cover 60, and an impeller 62 are housed in front housing 20, rear housing 22, nozzle assembly 24, a lock ring 64 and removeable lower filter 26. Motor 56 has a top drive shaft 51 and a bottom drive shaft 53 that are each rotatable. Removable lower filter 26 removably connects lock ring 64. Lock ring 64 is connected to nozzle assembly 24. Nozzle assembly 24 connects to lock ring 64, front housing 20 and rear housing 22 so that nozzle assembly 24 is rotatable. Ring of LEDs 46 and motor 56 are directly or indirectly connected to rechargeable batteries 44. Preferably, ring of LEDs 46 is directly or indirectly connected to rechargeable batteries 44 through a switch that is activated and deactivated by lighting button 30. Motor 56 is directly or indirectly connected to rechargeable batteries 44 preferably through a switch that is activated and deactivated by control button 29.

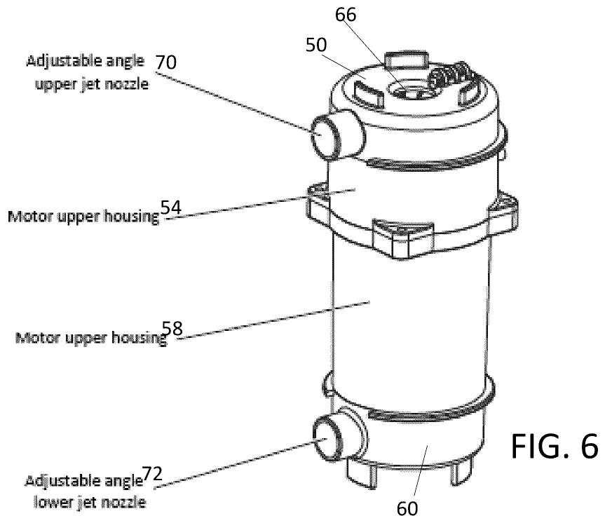

Referring to FIG. 6, a motor housing is formed by pump top housing 54 that connects to pump bottom housing 58 forming an interior volume that houses motor 56. Motor 56 is housed in pump top housing 54 and pump bottom housing 58 so that top drive shaft 51 extends from pump top housing 54 outside of the interior volume and bottom drive shaft 53 extends from pump bottom housing 58 outside of the interior volume. Impeller 52 is connected to top drive shaft 51 so that impeller 52 is outside of the interior volume formed by pump top housing 54 and pump bottom housing 58. Impeller 62 is connected to bottom drive shaft 53 so that impeller 62 is outside of the interior volume formed by pump top housing 54 and pump bottom housing 58. Pump top cover 50 is positioned over impeller 52 to connect to pump top housing 54. Pump bottom cover 60 is positioned over impeller 62 to connect to pump bottom housing 58. Pump top cover 50 connects to pump top housing 54 so that pump top cover 50 is rotatable relative to pump top housing 54. Pump bottom cover 60 is connected to pump bottom housing 58 so that pump bottom cover 60 is rotatable relative to pump bottom housing 58. Pump top cover 50 has an opening 66 positioned over impeller 52. Pump bottom cover 60 has an opening 68 positioned over impeller 62. Pump top cover 50 has a nozzle 70 that fits in nozzle 36. Pump bottom cover 60 has a nozzle 72 that fits in nozzle 38.

Referring to FIGS. 1-3, to use bath jet apparatus 10 a user positions bath jet apparatus 10 in a bathtub and presses suction cups 40, 42 against an inside wall of the bathtub to maintain a position of bath jet apparatus 10 in the bathtub. Bath jet apparatus 10 is fully submersible, so that the user can place the entirety of bath jet apparatus 10 under the waterline. Bath jet apparatus 10 is also cordless and rechargeable. Since bath jet apparatus 10 is cordless positioning bath jet apparatus 10 in the bathtub is also easier. Bath jet apparatus 10 is positioned so that nozzle 36 is at a waterline or under the water in the bathtub and nozzle 38 is positioned under the water in the bathtub. To turn bath jet apparatus 10 on, a user either presses control button 29 and/or air bubble button 34 to conduct electricity from rechargeable batteries 44 to motor 56 that rotates impeller 52 to draw water through removable upper filter 16 and front housing 20 and removable upper filter 18 and rear housing 22, so that the water can flow through opening 66 in pump top cover 50 pass impeller 52 and the water flows out of nozzle 70 and nozzle 36 into the bathtub. Nozzle 70 and nozzle 36 can be rotatable to adjust an angle of water flow. Motor 56 simultaneously rotates impeller 52 and impeller 62 so that impeller 62 draws water through removable lower filter 26 and lock ring 64 so that the water can flow through opening 68 in pump bottom cover 56 pass impeller 62 and the water flows out of nozzle 72 and nozzle 38. Nozzle 72 and nozzle 38 can be rotatable to adjust an angle of water flow. To turn bath jet apparatus 10 off, the user either presses control button 29 and/or air bubble button 34 to stop conducting electricity to motor 56. Second LED 33 can be illuminated when bath jet apparatus 10 is turned on. Bath jet apparatus 10 may or may not have control button 29 that can be depressed multiple times for different modes, for example, motor 56 can be connected to a controller so that pressing control button 29 multiple times increases the speed of rotation of top drive shaft 51 and a bottom drive shaft 53 to increase the speed of rotation of impeller 52 and impeller 62, respectively, and pressing control button 29 a predetermined number of times turns motor 56 off. Bath jet apparatus 10 can have a movable cover to selectively close nozzle 36 to provide additional water through nozzle 38. Bath jet apparatus 10 can have a movable cover to selectively close nozzle 38 to provide additional water through nozzle 36.

If the user desires mood lighting, the user can press lighting button 30 so that electricity is conducted from rechargeable batteries 44 to ring of LEDs 46 to illuminate ring of LEDs 46. First LED 31 can be illuminated when ring of LEDs 46 is illuminated. Cover 12 can have a portion or cover 12 can be entirely transparent or translucent. To turn the mood lighting off, the user can press lighting button 30 so that electricity is no longer conducted to ring of LEDs 46. The user can operate bath jet apparatus 10 to both turn on motor 56 and illuminated ring of LEDs 46 simultaneously.

Rechargeable batteries 44 are removably connectable to a power source, for example, a cable that connects to rechargeable batteries 44 through USB charging plug 32 to connect rechargeable batteries 44 to an electrical outlet.

Advantageously, bath jet apparatus 10 has vertical water jets with a dual nozzles system. Another advantage is that bath jet apparatus 10 is rechargeable so that bath jet apparatus 10 can be used without any cable so that cable connection to an electrical socket is not needed during operation. Bath jet apparatus 10 is fully submersible for the user easily fix it on different areas inside of the bathtub. Bath jet apparatus 10 includes a two level detachable filter that are separated located at an upper housing, namely, first removeable upper filter 16 and second removeable upper filter 18, and a lower housing, namely, removeable lower filter 26. The upper filter, namely, first removeable upper filter 16 and second removeable upper filter 18, can create extra water flow to the second water nozzle.

Bath jet apparatus 10 includes two adjustable angle water jet nozzles, namely, nozzles 36, 38. Nozzle 38 is located on the bottom and nozzle 36 can be just underneath the water surface in order to create two layers of water current inside of the bathtub and turbulent water on water surface. Bath jet apparatus 10 includes a vertical inner motor housing with two impellers, namely, impellers 52, 62, that are located at both ends and together with two water jet nozzles, namely, nozzles 70, 72, located in vertical positions. Bath jet apparatus 10 includes two rotary water jet nozzles and the distance between two vertical nozzles, namely, nozzles 36, 38, that is 40 mm or higher. Bath jet apparatus 10 includes a removeable bathtub bracket, namely, removeable bathtub bracket 28 to separate bath jet apparatus 10 easily. The upper part of bath jet apparatus 10 has a light therapy mood light feature in order for user relax in bathtub.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure should not be limited to the particular embodiment(s) disclosed as the best mode contemplated, but that the disclosure will include all embodiments falling within the scope of the appended claims.

What is claimed is:

1. A bath jet apparatus comprising:
a housing; and
a motor in the housing to rotate an impeller,
wherein the bath jet apparatus is cordless.

2. The bath jet apparatus of claim 1, wherein the bath jet apparatus is rechargeable.

3. The bath jet apparatus of claim 1, wherein the bath jet apparatus is fully submersible.

4. The bath jet apparatus of claim 1, further comprising a mood light connected to the housing.

5. The bath jet apparatus of claim 1, further comprising a first nozzle that is positioned above a second nozzle.

6. The bath jet apparatus of claim 5, wherein the first nozzle and the second nozzle are rotatable.

7. The bath jet apparatus of claim 1, further comprising an upper filter that is positioned above a lower filter.

8. The bath jet apparatus of claim 7, further comprising a first nozzle that is positioned above a second nozzle, wherein the upper filter is upstream of the first nozzle and the bottom filter is upstream of the second nozzle.

9. The bath jet apparatus of claim 1, wherein the impeller is a first impeller and a second impeller, wherein the motor rotates both the first impeller and the second impeller.

10. The bath jet apparatus of claim 5, wherein the impeller is a first impeller and a second impeller, wherein the motor rotates both the first impeller and the second impeller, and wherein the first impeller is aligned with the first nozzle and the second impeller is aligned with the second nozzle.
